(19) United States
(12) Patent Application Publication
(10) Pub. No.: US 2004/0018850 A1
(43) Pub. Date: Jan. 29, 2004

(54) Method of deciding transmit power level, wireless terminal, base station, and mobile communications system

(75) Inventors: Takayuki Ishiguro, Yokosuka-shi (JP); Hiroyuki Ishii, Yokosuka-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: NTT DoCoMo, Inc., Tokyo (JP)

(21) Appl. No.: 10/623,517

(22) Filed: Jul. 22, 2003

(30) Foreign Application Priority Data
Jul. 23, 2002 (JP) 2002-214282

(51) Int. Cl. H04B 7/00

(52) U.S. Cl. 455/522

(57) ABSTRACT

This invention provides a transmit power level deciding method that is carried out in a base station or in respective wireless terminals, those of which are constituents of a mobile communications system, for adequately controlling the transmit power level of uplink control signals to be sent from respective wireless terminals to the base station. For this purpose, respective wireless terminals measures a multiplex number of downlink control signals from the base station and decides the adequate transmit power level of the uplink control signal, which is containing NACK information, to be sent to the base station according to the measured multiplex number thereof, and respective wireless terminals controls the transmit power level of the uplink control signal. Consequently, it becomes possible for the mobile communications system to lessen degradation of receive quality of the uplink control signals to be received by the base station even in a case where the multiplex number of uplink control signals increases, and to lighten the load on the base station for its signal processing.

### CROSS-REFERENCE TO RELATED APPLICATION

This application is based upon and claims the benefit of priority from the prior Japanese Patent Application NO. 2002-214282, filed on Jul. 23, 2002. The entire contents of which are incorporated herein by reference.

### BACKGROUND OF THE INVENTION

1. Field of the Invention

This invention relates to a method of deciding a transmit power level in a mobile communications system, a wireless terminal, a base station and a mobile communications system.

2. Description of the Related Art

An ARQ (Automatic Repeat reQuest) system is employed as an error correcting system in IMT-2000 CDMA-TDD HSDPA (High Speed Downlink Packet Access).

In the ARQ system, a base station sends downlink data signals to wireless terminals. Respective wireless terminals returns to the base station ACK (ACKnowledgement) information in uplink control signals when it has correctly received the downlink data signals, whereas respective wireless terminals returns to the base station NACK (Negative ACKnowledgement) information in the uplink control signals when it could not receive the downlink data signals correctly.

The base station sends to a wireless terminal the next downlink data signal when it receives the uplink control signals and recognizes having received ACK from one of the wireless terminals, whereas it sends to a wireless terminal the same downlink data signal with the previous downlink data signal when it recognizes having received NACK from one of the wireless terminals.

Thermal noises, fading and interference errors with other users tend to occur on wireless signals. Therefore, there may occur a case where a base station incorrectly recognizes having received NACK in an uplink control signal from a wireless terminal even though the wireless terminal has correctly received the downlink data signal and sent ACK in the uplink control signal to the base station. In that case, the base station re-sends the same downlink data signal to the wireless terminal. A sequential number is assigned to each downlink data signal, and the wireless terminal can recognize whether or not it has received the same downlink data signal according to the sequential number assigned thereto. When the wireless terminal recognizes having received the same downlink data signal, it abandons the received downlink data signal in order to avoid duplicate reception of the same downlink data signal.

Contrarily, there may occur the opposite case where a base station incorrectly recognizes having received ACK in an uplink control signal from a wireless terminal even though the wireless terminal could not receive a downlink data signal correctly and sent NACK in the uplink control signal to the base station. In such a case, the base station recognizes that the wireless terminal has correctly received the downlink data signal, and it sends the next downlink data signal to the wireless terminal. Then, the wireless terminal results in loss of the downlink data signal that was not received correctly. In this latter case, the wireless terminal itself can not recover the loss of the necessary downlink data signal. Consequently, a higher layer of the protocol stack judges the necessity for the lost data and activates a retransmission procedure for the receive-failed downlink data signal. This recovery procedure causes problems of delay of communications and increase of error-rate.

In order to solve above mentioned problems, a method is proposed in a paper “Radio Access Network Physical Layer Procedures (TDD) (Release 5)”, 3GPP TS 25.224 V5.0.0 (2002-03). This method features a transmit power level of an uplink control signal containing NACK information being set higher by P_{offset} than a transmit power level of an uplink control signal containing ACK information. The principle of this method is as below.

The transmit power level of the uplink control signal for informing ACK P_{ACK} can be calculated by an expression (1) from a propagation damping value L_{P-CCPCH}, which is available from P-CCPCH, and a power of signal PRX_{des}, which is required by a wireless terminal for correct reception of the signal.

P_{ACK}=L_{P-CCPCH}+PRX_{des} (1)

The transmit power level of the uplink control signal containing NACK information P_{NACK} can be calculated by an expression (2).

P_{NACK}=P_{ACK}+P_{offset} (2)

A method for deciding the P_{offset} is proposed in a paper “Power control for HS-SCCH and HS-SICH in TDD”, 3GPP Tdoc R1-02-0293. This method features to decide the P_{offset} based on CQI (Channel Quality Indicator) that is information for deciding a quality of the downlink data signal.

However, there is a problem in that the proposed method can not decide the best fitting transmit power level P_{offset} because the method measures the quality of a downlink time slot defined in the IMT-2000 CDMA TDD and this slot is different from an uplink time slot provided for transmitting the uplink control signal.

Additionally, in a case where the base station sends downlink data signals to a plurality of wireless terminals, respectively, and respective wireless terminal sends uplink control signals in the same time slot, interferences occur between the uplink control signals which are sent from respective wireless terminals in the same time slot. Because of these interferences, there occurs another problem in that the quality of received signals in the base station changes according to the number of wireless terminals that send the uplink control signals simultaneously, and that the best P_{offset} also tends to change.

### SUMMARY OF THE INVENTION

One object of the present invention is to provide a new technique of deciding a transmit power level of wireless signals that can restrain degradation of a quality of uplink control signal being received by a base station and stop the increase of load to be burdened on the base station. This object can be achieved by arranging respective wireless terminals to measure a multiplex number of downlink control signals from the base station and to decide the transmit power level of the uplink control signal containing NACK according to the measured multiplex number of downlink control signals.

Another object of the present invention is to provide a new technique of deciding a transmit power level of wireless signals that can restrain degradation of a quality of uplink control signal being received by a base station. The object can be achieved by arranging a wireless terminal to detect errors of the uplink control signal and the base station to decide the transmit power level of the uplink control signals containing NACK according to the detected errors of the uplink control signals.

The first aspect of the present invention is a method of deciding a transmit power level carried out by a wireless terminal in a mobile communications system comprising the steps of: deciding a multiplex number of uplink control signals; and deciding a transmit power level according to the decided multiplex number of uplink control signals.

In this first aspect of the present invention, it is possible to arrange the wireless terminal to increase the transmit power level when the multiplex number of uplink control signals is large, and the wireless terminal to decrease the transmit power level when the multiplex number of uplink control signals is small.

In this first aspect of the present invention, it is also possible to arrange the wireless terminal to decide the multiplex number of uplink control signals according to a multiplex number of downlink control signals corresponding thereto. It is also possible to arrange the wireless terminal to measure the multiplex number of downlink control signals corresponding to the uplink control signals and to decide the multiplex number of uplink control signals according to the measured multiplex number of downlink control signals. Furthermore, it is possible to arrange the transmit power level of the uplink control signal to be a transmit power level of an uplink control signal for informing an incorrect receipt of the downlink data signal.

According to the first aspect of the present invention, in the mobile communications system including wireless terminals and a base station, a respective wireless terminal decides the multiplex number of uplink control signals and, according to the decided multiplex number, decides the transmit power level of the uplink control signal in order to control the transmit power level thereof for wireless communications between the wireless terminal and the base station. Consequently, it can restrain degradation of the quality of the uplink control signals even if the number of uplink control signals increase, and withhold increase of the number of signal processings required in the base station for adjustment of the transmit power level of the uplink control signals.

The second aspect of the present invention is a method of deciding a transmit power level carried out by a wireless terminal in a mobile communications system comprising the steps of: estimating a quality of an uplink control signal; and deciding a transmit power level according to the estimated quality of the uplink control signal.

In this second aspect of the present invention, it is possible to arrange the wireless terminal to increase the transmit power level of the uplink control signal when the quality of the uplink control signal for informing a failure of receipt of a downlink data signal from a base station is estimated as being degraded, and the wireless terminal to decrease the transmit power level of the uplink control signal when the quality of the uplink control signal for informing a successful receipt of the downlink data signal from the base station is estimated as being degraded. It is also possible to arrange the wireless terminal to estimate the quality of the uplink control signal according to a content of the downlink data signal from the base station.

In the second aspect of the present invention, it is also possible to arrange the wireless terminal to decide that the quality of the uplink control signal for informing a correct receipt of the downlink data signal is degraded, when the wireless terminal receives the downlink data signal of informing the same message as that which was previously received, after sending the uplink control signal for informing a correct receipt of the downlink data signal which was previously received.

In the second aspect of the present invention, it is also possible to arrange the wireless terminal to decide that the quality of the uplink control signal for informing an incorrect receipt of the downlink data signal is degraded, when the wireless terminal receives the downlink data signal informing a different massage from that which was previously received, after sending the uplink control signal for informing an incorrect receipt of the downlink data signal which was previously received.

In the second aspect of the present invention, it is further possible to arrange the transmit power level of the uplink control signal to be a transmit power level of an uplink control signal for informing an incorrect receipt of the downlink data signal.

According to the second aspect of the present invention, in the mobile communications system including wireless terminals and a base station, respective wireless terminals estimates the quality of the uplink control signal and, according to the estimated quality of the uplink control signal, decides the transmit power level of the uplink control signal for wireless communications between the wireless terminal and the base station. Consequently, it can restrain degradation of the quality of the uplink control signals, and withhold increase of the number of signal processings required in the base station for adjustment of the transmit power level of the uplink control signals.

The third aspect of the present invention is a method of deciding a transmit power level carried out by a base station in a mobile communications system comprising the steps of: deciding a multiplex number of uplink control signals; deciding a transmit power level according to the decided multiplex number of uplink control signals; and sending the decided transmit power level as an indication value to respective wireless terminals.

In the third aspect of the present invention, it is possible to arrange the base station to decide an increment in the transmit power level of the uplink control signals when the multiplex number of uplink control signals is large, and to decide a decrement in the transmit power level of the uplink control signals when the multiplex number of uplink control signals is small.

In the third aspect of the present invention, it is also possible to arrange the base station to decide the multiplex number of uplink control signals according to a multiplex number of downlink control signals.

In the third aspect of the present invention, it is further possible to arrange the base station to measure the multiplex number of downlink control signals and to decide the multiplex number of uplink control signals according to the measured multiplex number of downlink control signals.

According to the third aspect of the present invention, in the mobile communications system including wireless terminals and a base station, the base station decides the multiplex number of uplink control signals from the wireless terminals and decides an adequate transmit power level of the uplink control signals according to the decided multiplex number of uplink control signals in order to inform to the wireless terminals. Consequently, it becomes possible for the wireless terminals to adequately communicate with the base station merely by controlling the transmit power level of the uplink control signals to meet with an indication value indicated from the base station, and it can withhold increase of the number of signal processings in the base station required for adjustment of the transmit power level of the uplink control signals.

The fourth aspect of the present invention is a method of deciding a transmit power level carried out by a base station in a mobile communications system comprising the steps of: detecting a quality of an uplink control signal; deciding a transmit power level according to the detected quality of the uplink control signal; and transmitting to a wireless terminal the decided transmit power level as an indication value.

In the fourth aspect of the present invention, it is possible to arrange the base station to decide to increase the transmit power level of the uplink control signal from the wireless terminal when the base station decides that the quality of the uplink control signal from the wireless terminal for informing an incorrect receipt of a downlink data signal is degraded, and to decide to decrease the transmit power level of the uplink control signal from the wireless terminal when the base station decides that the quality of the uplink control signal from the wireless terminal for informing a correct receipt of the downlink data signal is degraded.

In the fourth aspect of the present invention, it is also possible to arrange the base station to decide the quality of the uplink control signal according to a bit error rate or a signal-to-noise ratio of at least one of a portion informing the correct receipt of the downlink data signal and a blank portion thereof.

In the fourth aspect of the present invention, it is further possible to arrange the transmit power level of the uplink control signal to be a transmit power level of an uplink control signal for informing an incorrect receipt of the downlink data signal.

According to the method of the fourth aspect of the present invention, in the mobile communications system including the wireless terminal and the base station, the base station side solely detects the quality of the uplink control signal from the wireless terminal, decides an adequate transmit power level of the uplink control signal according to the detected quality thereof and indicates the decided transmit power level to the wireless terminal. Consequently, the wireless terminal side can adequately carry out wireless communications with the base station by merely controlling the transmit power level of the uplink control signal so as to agree with the indicated transmit power level. As a result, the load for adjustment of the transmit power level of the uplink control signal that is required for the wireless terminal side does not increase.

The fifth aspect of the present invention is a method of deciding a transmit power level in a mobile communications system, in which the system includes a plurality of wireless terminals and a base station, comprising the steps of: (a) a step that the plurality of wireless terminals estimate a quality of an uplink control signal, respectively; (b) a step that the plurality of wireless terminals inform a degradation of the uplink control signal to the base station when they have estimated the degradation thereof, respectively; (c) a step that the base station decides to increase the transmit power level of the uplink control signal from one of the plurality of wireless terminals when the base station receives from one of the plurality of wireless terminals an information that the quality of the uplink control signal for informing an incorrect receipt of a downlink data signal is degraded, whereas the base station decides to decrease the transmit power level of the uplink control signal from one of the plurality of wireless terminals when the base station receives from one of the plurality of wireless terminals an information that the quality of the uplink control signal for informing a correct receipt of the downlink data signal is degraded; and (d) a step that the base station sends an indication value of the decided transmit power level of the uplink control signal to all of the plurality of wireless terminals.

According to the fifth aspect of the present invention, in the mobile communications system including the wireless terminals and the base station, a respective wireless terminal estimates the quality of the uplink control signal and informs the base station of the respective estimated qualities. The base station judges the respective estimated qualities of the uplink control signals from a respective wireless terminal, and where necessary, the base station indicates the adequate transmit power level to all wireless terminals. Consequently, respective wireless terminals can adequately carry out wireless communications with the base station by merely controlling the transmit power level of the uplink control signal so as to agree with the indicated transmit power level.

The sixth aspect of the present invention is a wireless terminal comprising: a multiplex number of signals deciding means for deciding a multiplex number of uplink control signals; a transmit power level deciding means for deciding a transmit power level of the uplink control signals according to the multiplex number of uplink control signals decided by the multiplex number of signals deciding means; and a transmit power control means for controlling a transmit power level of the uplink control signals according to the decided transmit power level by the transmit power level deciding means.

In the sixth aspect of the present invention, it is possible to arrange the transmit power level deciding means to decide an increment in the transmit power level when the multiplex number of uplink control signals is large, and to decide a decrement in the transmit power level when the multiplex number of uplink control signals is small.

In the sixth aspect of the present invention, it is possible to arrange the multiplex number deciding means to decide the multiplex number of uplink control signals according to a multiplex number of downlink control signals corresponding thereto. It is also possible to arrange the multiplex number deciding means to measure the multiplex number of downlink control signals corresponding to the uplink control signals and to decide the multiplex number of uplink control signals according to the measured multiplex number of downlink control signals.

In the sixth aspect of the present invention, it is further possible to arrange the transmit power level of the uplink control signal to be a transmit power level of an uplink control signal for informing an incorrect receipt of a downlink data signal from a base station.

According to the sixth aspect of the present invention, in the mobile communications system including a plurality of wireless terminals and a base station, a respective wireless terminal solely decides the multiplex number of uplink control signals and decides the transmit power level of the uplink control signal according to the decided multiplex number of uplink control signals to control the transmit power level thereof. Consequently, it is possible to lessen the degradation of the receive quality of the uplink control signals even if the multiplex number of uplink control signals increases, and to prevent an increase of processes required to respective wireless terminals in order to adjust the transmit power level of the uplink control signal.

The seventh aspect of the present invention is a wireless terminal comprising: a signal quality estimation means for estimating a quality of an uplink control signal; a transmit power level deciding means for deciding a transmit power level according to the estimated quality of the uplink control signal; and a transmit power control means for controlling a transmit power level of the uplink control signal according to the decided transmit power level by the transmit power level deciding means.

In the seventh aspect of the present invention, it is possible to arrange the signal quality estimation means to estimate the quality of the uplink control signal for informing an incorrect receipt of a downlink data signal from a base station and the quality of the uplink control signal for informing a correct receipt of the downlink data signal; and the transmit power level deciding means to decide an increment in the transmit power level of the uplink control signal when the signal quality estimation means estimates that the quality of the uplink control signal for informing an incorrect receipt of the downlink data signal is degraded, and to decide a decrement in the transmit power level of the uplink control signal when the signal quality estimation means estimates that the quality of the uplink control signal for informing a correct receipt of the uplink control signal is degraded.

In the seventh aspect of the present invention, it is also possible to arrange the signal quality estimation means to estimate the quality of the uplink control signal according to the downlink data signal from the base station. It is also possible to arrange the signal quality estimation means to decide that the quality of the uplink control signal for informing a correct receipt of the downlink data signal is degraded in a case where the wireless terminal receives the downlink data signal informing the same massage as that which was previously received after the wireless terminal sent an uplink control signal for informing a correct receipt of the downlink data signal which was previously received. It is also possible to arrange the signal quality estimation means to decide that the quality of the plink control signal for informing an incorrect receipt of the downlink data signal is degraded in a case where the wireless terminal receives the downlink data signal informing a different message from that which was previously received after the wireless terminal sent an uplink control signal for informing an incorrect receipt of the downlink data signal which was previously received.

In the seventh aspect of the present invention, it is further possible to arrange the transmit power level of the uplink control signal to be a transmit power level of an uplink control signal for informing an incorrect receipt of a downlink data signal from a base station.

According to the seventh aspect of the present invention, in the mobile communications system including a wireless terminal and a base station, the wireless terminal solely estimates the quality of the uplink control signal and decides the transmit power level thereof. Consequently, the system can lessen the degradation of the receive quality of the uplink control signal and it can prevent increase of processes required to the base station for adjusting the transmit power level of the uplink control signal.

The eighth aspect of the present invention is a base station comprising: a multiplex number of signals deciding means for deciding a multiplex number of uplink control signals from a plurality of wireless terminals; a transmit power level deciding means for deciding a transmit power level according to the decided multiplex number of uplink control signals; and a transmit power level indicating means for sending the decided transmit power level as an indication value to the plurality of wireless terminals.

In the eighth aspect of the present invention, it is possible to arrange the transmit power level deciding means to decide an increment in the transmit power level of the uplink control signals when the decided multiplex number of uplink control signals is large, and to decide a decrement in the transmit power level of the uplink control signals when the decided multiplex number of uplink control signals is small.

In the eighth aspect of the present invention, it is also possible to arrange the multiplex number of signals deciding means to decide the multiplex number of uplink control signals according to a multiplex number of downlink control signals. It is also possible to arrange the multiplex number of signals deciding means to measure the multiplex number of downlink control signals and to decide the multiplex number of uplink control signals according to the measured multiplex number of downlink control signals.

In the eighth aspect of the present invention, it is further possible to arrange the transmit power level of the uplink control signals to be a transmit power level of uplink control signals for informing an incorrect receipt of downlink data signals.

According to the eighth aspect of the present invention, in the mobile communications system including a plurality of wireless terminals and a base station, the base station solely decides the multiplex number of uplink control signals and also decides an adequate transmit power level of the uplink control signals according to the decided multiplex number thereof, and indicates the adequate transmit power level of the uplink control signals to the plurality of wireless terminals. Consequently, the wireless terminals can adequately carry out wireless communications with the base station by merely controlling the transmit power level of the uplink control signals so as to agree with the indicated transmit power level. As a result, the load for adjustment of the transmit power level of the uplink control signals that is required to respective wireless terminals does not increase.

The ninth aspect of the present invention is a base station comprising: a signal quality detecting means for detecting a quality of an uplink control signal from a wireless terminal; a transmit power level deciding means for deciding a transmit power level according to the detected quality of the uplink control signal; and a transmit power level indicating means for sending the decided transmit power level as an indication value to the wireless terminal.

In the ninth aspect of the present invention, it is possible to arrange the signal quality deciding means to decide that a quality of an uplink control signal from the wireless terminal for the purpose of informing an incorrect receipt of a downlink data signal is degraded, and to decide that a quality of an uplink control signal from the wireless terminal for the purpose of informing a correct receipt of the downlink data signal is degraded; and the transmit power level deciding means to decide to increase the transmit power level of the uplink control signal from the wireless terminal when the base station received from the wireless terminal an information that the quality of the uplink control signal for informing the incorrect receipt of the downlink data signal is degraded, and to decide to decrease the transmit power level of the uplink control signal from the wireless terminal when the base station received from the wireless terminal an information that the quality of the uplink control signal for informing the correct receipt of the downlink data signal is degraded. It is also possible to arrange the signal quality deciding means to decide the quality of the uplink control signal according to a bit error rate or a signal-to-noise ratio of at least one of a portion informing the correct receipt of the downlink data signal and a blank portion thereof.

In the ninth aspect of the present invention, it is further possible to arrange the transmit power level of the uplink control signal to be a transmit power level of an uplink control signal from the wireless station for the purpose of informing an incorrect receipt of the downlink data signal.

According to the base station of the ninth aspect of the present invention, in the mobile communications system including the wireless terminal and the base station, the base station solely detects the quality of the uplink control signal from the wireless terminal, decides an adequate transmit power level of the uplink control signal according to the detected quality thereof, and informs the adequate transmit power level thereof to the wireless terminal. Consequently, the wireless terminal side can adequately carry out wireless communications with the base station by merely controlling the transmit power level of the uplink control signal so as to agree with the indicated transmit power level by the base station. As a result, the load for adjustment of the transmit power level of the uplink control signal that is required to the wireless terminal does not increase.

The tenth aspect of the present invention is a mobile communications system comprising a plurality of wireless terminals and a base station: wherein the plurality of wireless terminals respectively are configured to estimate a quality of uplink control signal and to inform degradation of the quality of the uplink control signals to the base station in a case where one of the respective wireless terminals estimates the degradation of the quality of the uplink control signals; and the base station is configured to decide to increase a transmit power level of the uplink control signals from each of the wireless terminals when the base station received from one of the wireless terminals an information that the quality of the uplink control signals for informing an incorrect receipt of the downlink data signals is degraded and to decide to decrease the transmit power level of the uplink control signals from each of the wireless terminals when the base station received from one of the wireless terminals an information that the quality of the uplink control signals for informing a correct receipt of the downlink data signals is degraded, and to send an indication value of the transmit power level to all of the plurality of wireless terminals.

According to the base station of the ninth aspect of the present invention, in the mobile communications system including the wireless terminal and the base station, respective wireless terminals estimates the quality of the uplink control signals and informs the estimated quality thereof to the base station. The base station judges the quality of the uplink control signals from all the wireless terminals, and where necessary, indicates to all the wireless terminals an adequate transmit power level of the uplink control signals. Consequently, respective wireless terminals can adequately carry out wireless communications with the base station by merely controlling the transmit power level of the uplink control signals so as to agree with the indicated transmit power level.

### BRIEF DESCRIPTION OF THE DRAWINGS

FIG. 1 is a schematic diagram showing a common hardware structure of all embodiments of a mobile communications system of the present invention.

FIG. 2 is a schematic diagram showing a functional structure of a wireless terminal used in a mobile communications system of the first embodiment of the present invention.

FIG. 3 is a timing chart showing a relationship between communication frames and respective time slots in each communication frames, and transmit- and receive-timings of communication signals between a base station and wireless terminals.

FIG. 4 is a flowchart showing a transmit power control process carried out by a wireless terminal of the first embodiment.

FIG. 5 is a schematic diagram showing a functional structure of a wireless terminal used in a mobile communications system of the second embodiment of the present invention.

FIG. 6 is a schematic diagram showing a functional structure of a base station used in the mobile communications system of the second embodiment.

FIGS. 7A and 7B are flowcharts showing a transmit power control process carried out by the wireless terminal of the second embodiment.

FIG. 8 is a flowchart showing a transmit power level deciding process carried out by the base station of the second embodiment.

FIG. 9 is a sequence diagram showing a transmit power level deciding process carried out between the wireless terminal and the base station.

FIG. 10 is an error decision table of an uplink control signal that is referred by the base station of the second embodiment.

FIG. 11 is a schematic block diagram showing a functional structure of a base station used in a mobile communications system of the third embodiment of the present invention.

FIG. 12 is a flowchart of a transmit power level deciding process carried out by the base station of the third embodiment.

FIG. 13 is a data structure of an uplink control signal that is sent from the wireless terminal of the third embodiment.

FIG. 14 is a schematic block diagram showing a functional structure of a base station used in a mobile communications system of the fourth embodiment of the present invention.

FIG. 15 is a flowchart of a transmit power level deciding process carried out by the base station of the fourth embodiment.

### DETAILED DESCRIPTION OF THE PREFERED EMBODIMENTS OF THE PRESENT INVETION

Hereinafter, the present invention will be described with reference to the drawings.

[First Embodiment]

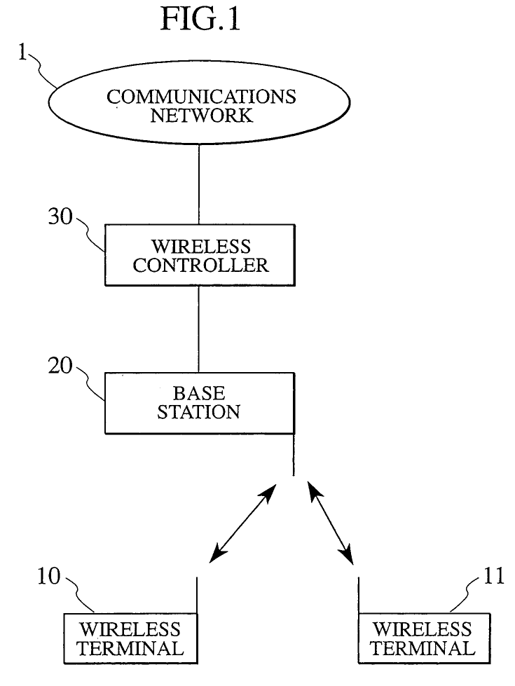

FIG. 1 illustrates a mobile communications system in accordance with the first embodiment of the present invention. The mobile communication system includes wireless terminals 10 and 11 such as a cellular telephone, a PDA or the like which can wirelessly data-communicate. The mobile communications system also includes a base station 20 and a wireless controller 30. In this embodiment, the mobile communication system is connected with a communications network 1 via the wireless controller 30.

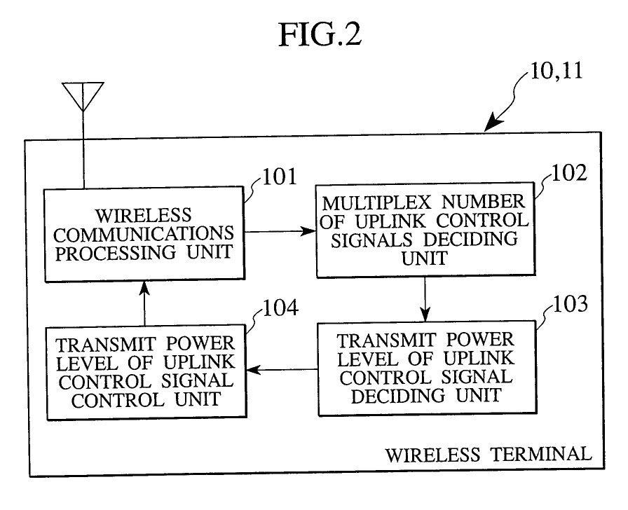

As shown in FIG. 2, respective wireless terminals 10 and 11 has a wireless communications processing unit 101, a multiplex number of uplink control signals deciding unit 102, a transmit power level of uplink control signals deciding unit 103 and a transmit power level of uplink control signals control unit 104. The wireless communications processing unit 101 wirelessly communicates with the base station 30. The multiplex number of uplink control signals deciding unit 102 decides the multiplex number of uplink control signals according to the multiplex number of downlink control signals received by the wireless communications processing unit 101. The transmit power level of uplink control signals deciding unit 103 judges whether to raise or lower the transmit power level of the uplink control signals according to the multiplex number of uplink control signals decided by the multiplex number of uplink control signals deciding unit 102. The transmit power level of uplink control signals control unit 104 controls a transmit power level of uplink control signals output from the wireless communications processing unit 101 according to an indication value given by the transmit power level of uplink control signals deciding unit 103.

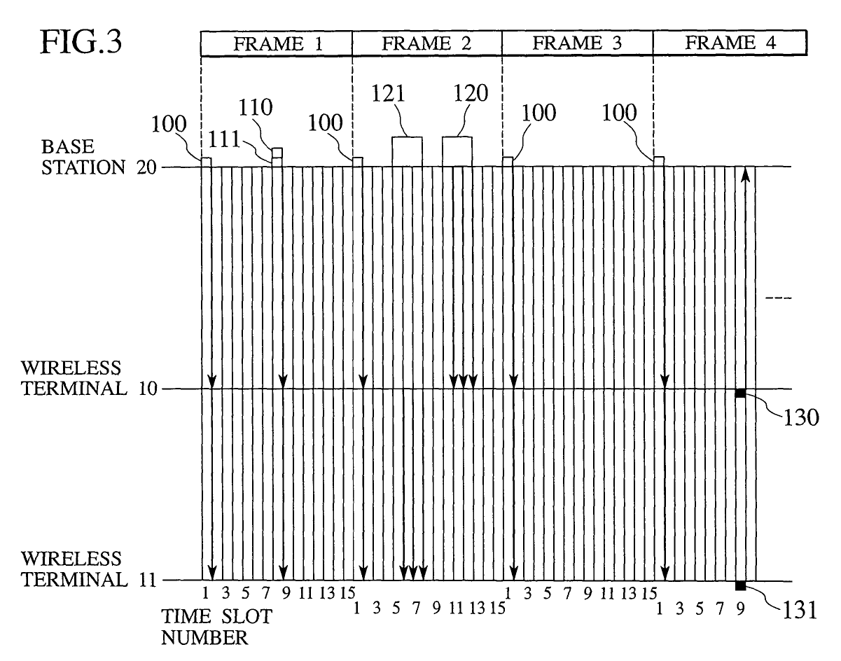

The wireless terminals 10 and 11 and the base station 20 wirelessly communicate each other on IMT-2000 CDMA-TDD (Code Division Multiple Access—Time Division Duplex) system. As shown in FIG. 3, IMT-2000 CDMA-TDD system uses frames of 10 ms length and fifteen time slots numbered 1 to 15 in each frame. The time slots numbered 1 to 15 are derived from each frame by dividing each frame into fifteen. In each time slot, downlink signals from the base station 20 to the wireless terminals 10 and 11 and uplink signals from the wireless terminals 10 and 11 to the base station 20 are defined. On the CDMA system, the base station 20 can simultaneously communicate with a plurality of wireless terminals 10 and 11 in one time slot.

The wireless controller 30 defines uplink or downlink for each time slot. The wireless controller 30 also assigns the time slots for an annunciation signal 100, downlink control signals 110 and 111, uplink control signals 130 and 131, and downlink data signals 120 and 121. Here in FIG. 3, as an example, it is illustrated that the wireless controller 30 assigns the annunciation signal 100 to the time slot 1, the downlink control signals 110 and 111 to the time slot 8, the uplink control signals 130 and 131 to the time slot 9, and the downlink data signals 120 and 121 to the time slots 5 to 7 and 10 to 12.

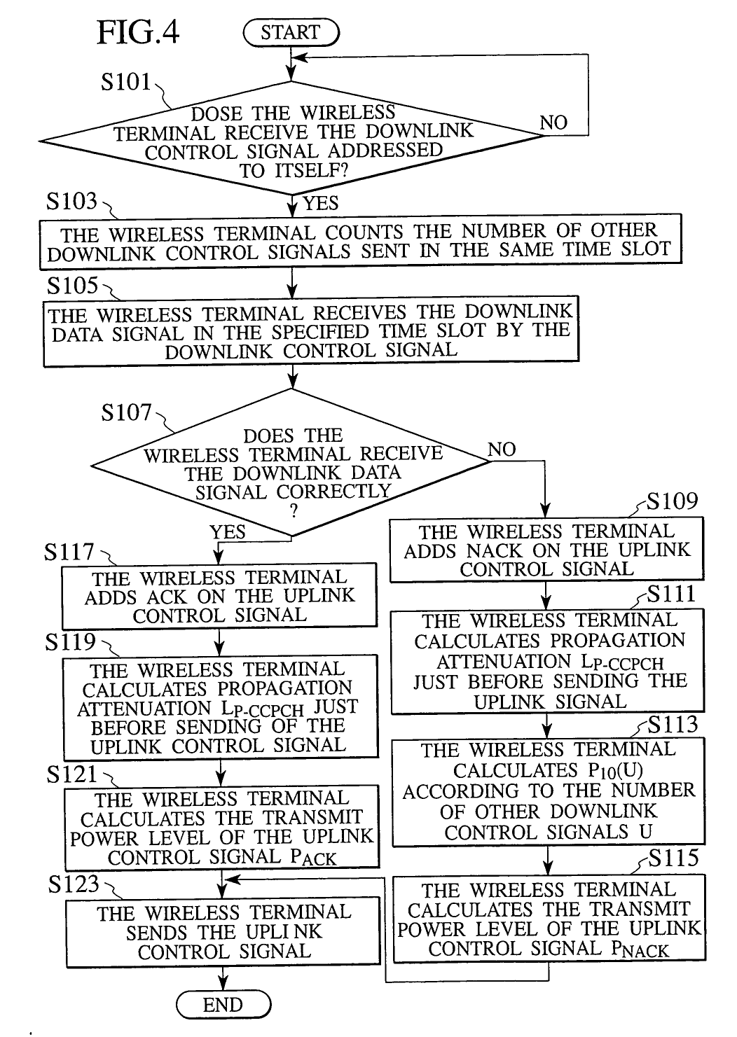

A transmit power level deciding method for the uplink control signals 130 carried out by each wireless terminal in this mobile communications system will be described with reference to a flowchart in FIG. 4.

A transmit power level of the uplink control signal 130 of the wireless terminal 10 is decided by processes according to the flowchart in FIG. 4. The wireless terminals 10 and 11 store an incremental transmit power level for NACK P_{offset}, a transmit power level PTX_{P-CCPCH} of the annunciation signal 100 from the base station 20, a receive power level PRX_{des} of the uplink control signals 130 and 131 that are necessary for the base station 20 to correctly receive therefrom. The wireless terminals 10 and 11 usually store constant values for these pieces of information in their memories. However, it is possible to arrange that the base station 20 sends these pieces of information in the annunciation signal 100, in the downlink control signals 110 and 111 or in the downlink data signals 120 and 121 to the wireless terminals 10 and 11, respectively, and that the wireless terminals 10 and 11 store the information into their memories.

The base station 20 transmits to the wireless terminals 10 and 11 the annunciation signal 100 in the time slot 1 of each frame. The base station 20 determines whether or not to send the downlink data signals 120 and 121 to the wireless terminals 10 and 11 according to whether or not the base station 20 has data to be sent to the wireless terminals 10 and 11. However, it is possible to arrange the base station to make this decision according to the degradation of quality of the wireless communications between the base station 20 and the wireless terminals 10 and 11. Measurement of the degree of degradation of the communications quality is carried out against the uplink control signals from the wireless terminals 10 and 11, which are previously received by the base station 20. Hereinafter, it is assumed that the base station 20 has determined to send the downlink data signals 120 and 121 to the wireless terminals 10 and 11.

The base station 20 firstly sends the downlink control signals to a wireless terminal, to which the downlink data signals were sent. Here, one downlink control signal 110 to the wireless terminal 10 and another downlink control signal 111 to the wireless terminal 11 are both sent in the same time slot 8 of the frame 1. The downlink control signal 110 includes information about the time slot number, in which the downlink data signal 120 is to be sent, and a division code and a modulation system used for the downlink control signal 120. The downlink control signal 111 includes information about the time slot number, in which the downlink data signal 121 is to be sent, and a division code and a modulation system used for the downlink control signal 121. Also here, it is assumed that the downlink control signal 110 indicates that the downlink data signal 120 is to be sent in the time slots 10, 11 and 12, and that the downlink control signal 111 indicates that the downlink data signal 121 is to be sent in the time slots 5, 6 and 7.

In the stepIn the step S101 of the flowchart in FIG. 4, the wireless terminal 10 receives the downlink control signal 110 in the time slot 8 in the frame 1, and specifies that it will receive the downlink data signal 120 in the time slots 10, 11 and 12 of the frame 2, which are more than six time slots later from the time slot 8 of the frame 1.

In the step S103, the wireless terminal 10 counts a multiplex number U of downlink control signals, which are code-multiplexed in the same time slot. This counting is carried out according to a received midamble, which is provided for channel estimation of the downlink control signal 110. The wireless terminal 10, here, counts the multiplex number U is one (U=1) because the code-multiplexed downlink control signal with the downlink control signal 110 is only the downlink control signal 111.

In the step S105, the wireless terminal 10 receives the downlink data signal 120 in the time slots of the frame 2 specified according to the information of the downlink control signal 110.

In the step S107, the wireless terminal 10 judges whether or not it has correctly received the downlink data signal 120. If it was received erroneously, the wireless terminal 10 carries out a process of the step S109, and if it was received correctly, the wireless terminal 10 carries out a process of the step S117. In this case, the wireless terminal 10 is assumed to have erroneously received the downlink data signal 120.

In the step S109, the wireless terminal 10 adds NACK information in an uplink control signal 130.

In the step S111, the wireless terminal 10 calculates a propagation attenuation L_{P-CCPCH,10} of the annunciation signal 100 of just before sending the uplink control signal 130. The calculation method of the propagation attenuation L_{P-CCPCH,10} is as follows. First, the wireless terminal 10 calculates a receive power level PRX_{P-CCPCH,10} of the annunciation signal 100 of just before sending the uplink control signal 130. The propagation attenuation L_{P-CCPCH,10} of the annunciation signal 100 on the way from the base station 20 to the wireless terminal 10 can be described as the following expression (3).

L_{P-CCPCH,10}=PTX_{P-CCPCH}+PRX_{P-CCPCH,10} (3)

In the step S113, the wireless terminal 10 calculates an increment in the power level P₁₀(U). The P₁₀(U) is a power value determined according to the number of code-multiplexed downlink control signals U, which was computed at the reception of the downlink control signal 110, and P₁₀(U) is greater corresponding to the greatness of the multiplex number of downlink control signals. For instance, it is definable as the following expression (4).

P₁₀(U)=αU (4)

Here, α is a constant defined beforehand. A reference table that can define relationship between the number of downlink control signals U and P₁₀(U) is stored in the memory of the wireless terminal 10. It is possible to arrange the base station 20 to send data of the reference table to the wireless terminal 10 beforehand.

In the step S115, the wireless terminal 10 determines the transmit power level P_{NACK} of the uplink control signal 130 according to the following expression (5).

P_{NACK}=L_{P-CCPCH,10}+PRX_{des}+P_{offset}+P₁₀(U) (5)

In the step S123, the wireless terminal 10 sends to the base station 20 the uplink control signal 130 by the transmit power level P_{NACK} in the time slot 9 of the frame 4, which is more than 19 time slots later.

On the other hand, the wireless terminal 10 takes the following process when it could receive the downlink data signal 120 correctly in the step S107.

In the step S117, the wireless terminal 10 adds ACK information in the uplink control signal 130.

In the step S119, the wireless terminal 10 calculates a propagation attenuation L_{P-CCPCH,10} of the annunciation signal 100 of just before sending the uplink control signal 130.

In the step S121, the wireless terminal 10 determines a transmit power level P_{ACK} of the uplink control signal 130 according to the following expression (6).

P_{ACK}=L_{P-CCPCH,10}+PRX_{des} (6)

In the step S123, the wireless terminal 10 sends to the base station 20 the uplink control signal 130 by the transmit power level P_{ACK} in the time slot 9 of the frame 4, which is more than 19 time slots later.

As set forth above, according to the mobile communications system of the first embodiment of the present invention, the wireless terminals 10 and 11 measure the multiplex number of downlink control signals, and determine the transmit power level of the uplink control signals containing NACK information according to the measured multiplex number. Since the multiplex number of uplink control signals results in to be equal to the multiplex number of corresponding downlink control signals that are previously received, the degree of the degradation of receive quality of uplink control signals can be lessened even when the multiplex number of uplink control signals increases.

[Second Embodiment]

A mobile communications system in accordance with the second embodiment of the present invention will be described hereinafter. The schematic diagram of the second embodiment is the same as that of the first embodiment shown in FIG. 1. The feature of the second embodiment is that wireless terminals 10 and 11 estimate the quality of uplink control signals 130 and 131 according to the content of downlink data signals from a base station 20 and determine the transmit power level of the uplink control signals, and that the base station 20 detects the quality of the uplink control signals from the wireless terminals and indicates to the wireless terminals 10 and 11 an adjustment of transmit power level of the uplink control signals according to the detected quality of signal.

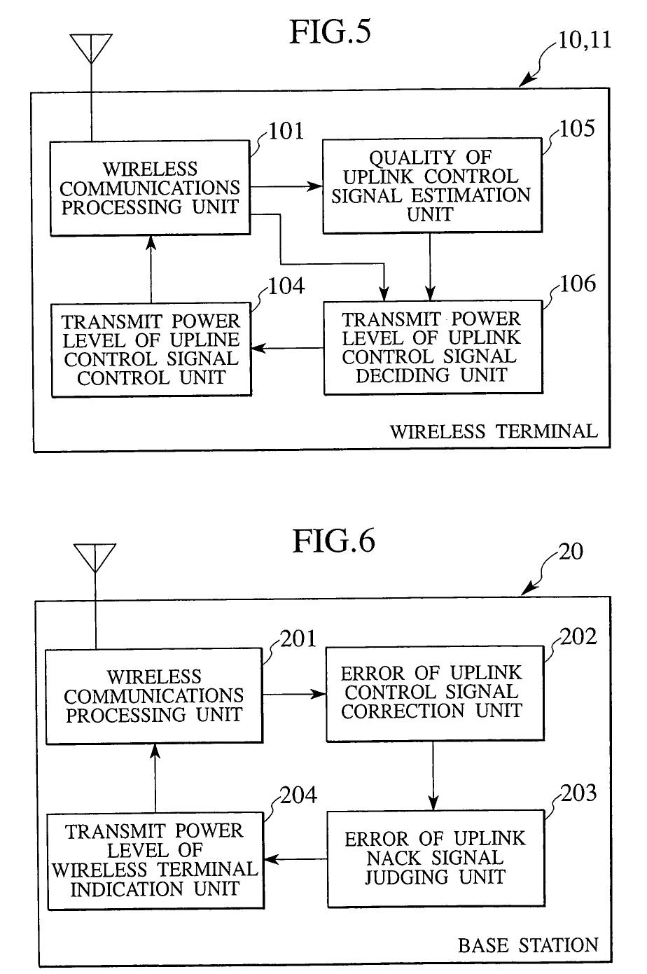

As shown in FIG. 5, respective wireless terminals 10 and 11 includes a wireless communications processing unit 101, a quality of uplink control signal estimation unit 105, a transmit power level of uplink control signals deciding unit 106, and a transmit power level of uplink control signals control unit 104. The wireless communications processing unit 101 carries out necessary wireless communications with the base station 20. The quality of uplink control signal estimation unit 105 estimates the quality of the uplink control signals 130 according to the content contained in downlink data signals, which are received by the wireless communications processing unit 101. The transmit power level of uplink control signals deciding unit 106 judges the necessity of an increment/decrement in the transmit power level of the uplink control signals according to the quality of the uplink control signals estimated by the quality of uplink control signal estimation unit 105. The transmit power level of uplink control signals control unit 104 controls the transmit power level of the uplink control signals 130 that are to be transmitted from the wireless communications processing unit 101.

As shown in FIG. 6, the base station 20 includes a wireless communications processing unit 201, an uplink control signal error correction unit 202, an uplink NACK signal error judging unit 203, and a transmit power level of wireless terminal indication unit 204. The wireless communications processing unit 201 carries out wireless communications with the wireless terminals 10 and 11. The uplink control signal error correction unit 202 detects and corrects errors in the uplink control signals received by the wireless communications processing unit. 201. The uplink NACK signal error judging unit 203 judges errors in the uplink control signal that informs NACK message. The transmit power level of wireless terminal indication unit 204 decides whether the transmit power level of the uplink control signals from the wireless terminal 10 and 11 should be increased or decreased according to the judgment of the uplink NACK signal error judging unit 203, and indicates the wireless communications processing unit 201 to inform to all the wireless terminals 10 and 11 of increment or decrement in their transmit power level of the uplink control signals.

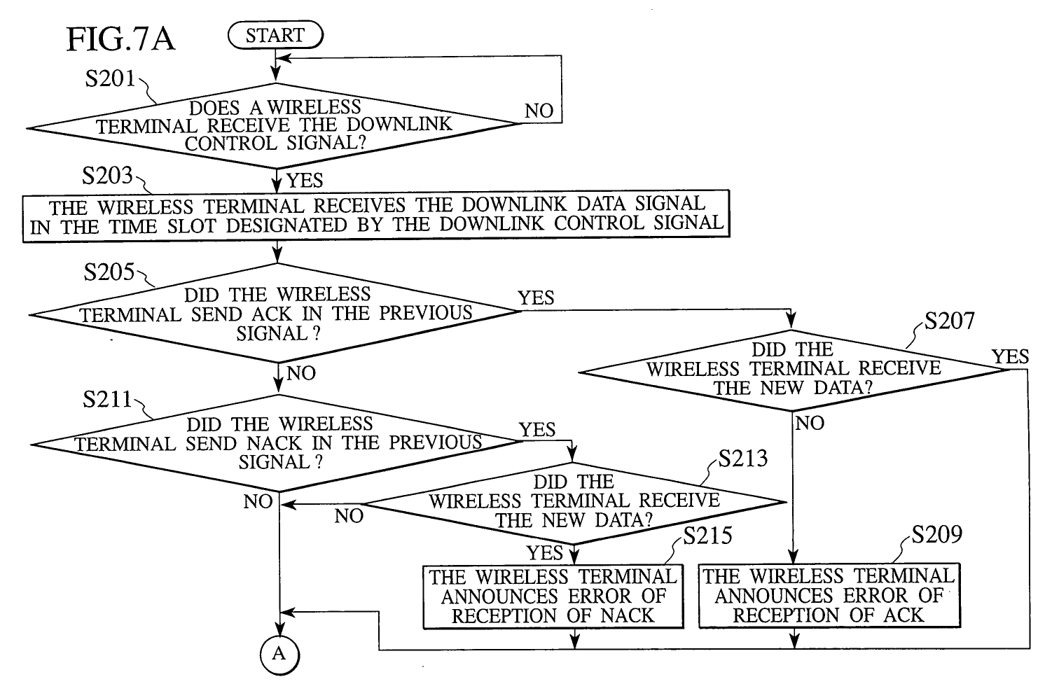

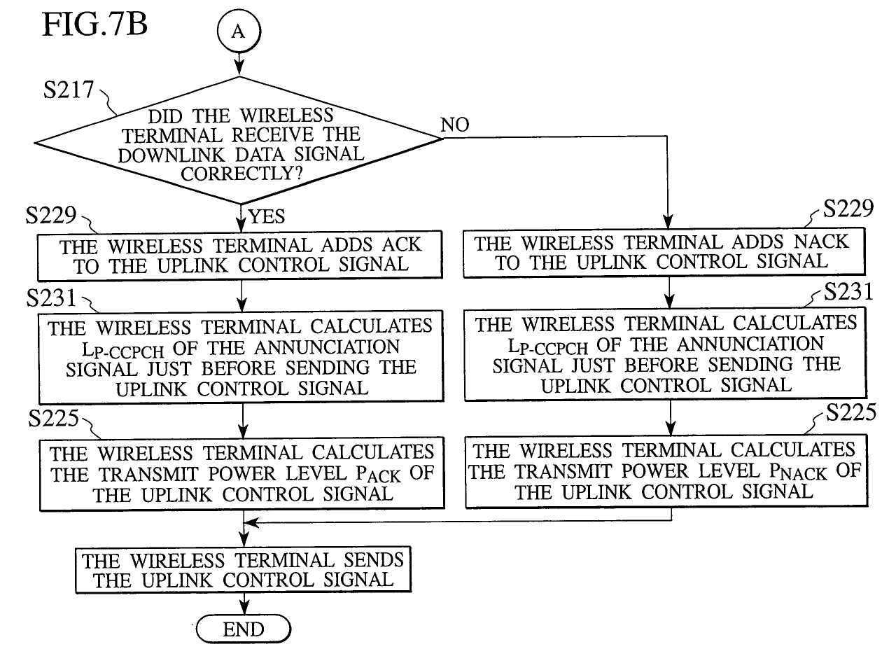

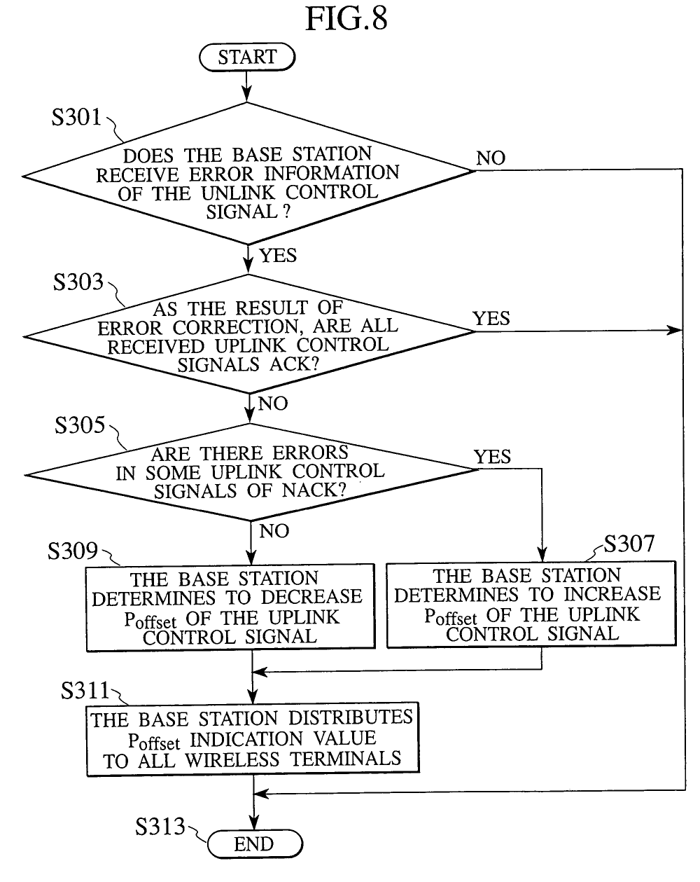

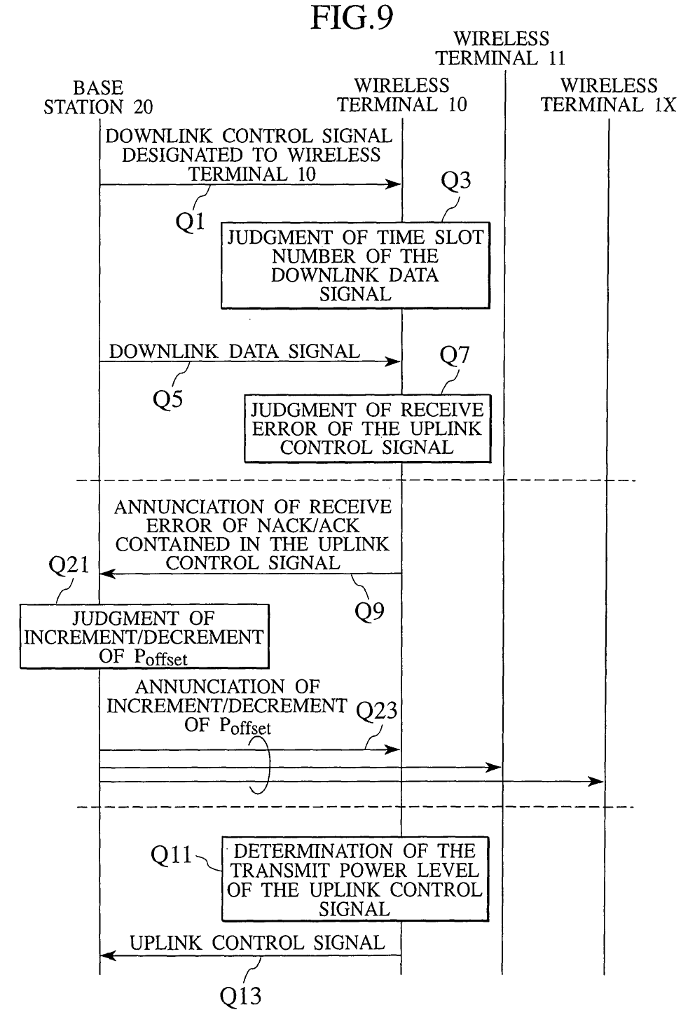

A transmit power level deciding method carried out by respective wireless terminals and the base station in the mobile communications system of the second embodiment will be described with reference to FIGS. 7-10 hereinafter. Flowcharts in FIGS. 7A and 7B illustrate processes carried out by respective wireless terminals 10 and 11, a flowchart in FIG. 8 illustrates processes carried out by the base station 20, and the sequence diagram in FIG. 9 illustrates cooperative processes between respective wireless terminals 10 and 11 and the base station 20.

It is assumed here that the wireless terminal 10 has previously received downlink data signals 120 from the base station 20, judged whether or not it could correctly receive the downlink data signals 120, and sent the uplink control signals 130 containing ACK or NACK information to the base station 20.

The wireless terminals 10 and 11 store a power increment for NACK P_{offset}. This power increment for NACK P_{offset} is sent at periodical timing or arbitrary timing from the base station 20 in an annunciation signal 100, in downlink control signals 110 and 111, or in the downlink data signals 120 and 121, and the wireless terminals 10 and 11 store the power increment value for NACK in their memories. The wireless terminals 10 and 11 also store a transmit power level PTX_{P-CCPCH} of the annunciation signal 100 from the base station 20 and a receive power level PRX_{des} of the uplink control signals 130 and 131 to be received by the base station 20. These pieces of information are sent from the base station 20, and they are stored in memories of the wireless terminals 10 and 11.

The base station 20 sends to the wireless terminals 10 and 11 the annunciation signal 100 in the time slot 1 of each frame as shown in FIG. 3. The base station 20 judges whether or not to send the downlink data signals 120 and 121 to the wireless terminals 10 and 11. Here, the base station 20 has judged to send the downlink data signals 120 and 121 to the wireless terminals 10 and 11, respectively.

The base station 20 sends the downlink control signal 110 to the wireless terminal 10 and the downlink control signal 111 to the wireless terminal 11 in the time slot 8 of the frame 1. The downlink control signal 110 contains information of the downlink data signal 120 being sent in the time lots 10, 11 and 12, and the downlink control signal 111 contains information of the downlink data signal 121 being sent in the time slots 5, 6 and 7.

In the step S201 of the flowchart in FIGS. 7A and 7B, and also in the steps Q1 and Q3 in the sequence diagram in FIG. 9, the wireless terminal 10 receives the downlink control signal 110 in the time slot 8 of the frame 1, and recognizes to receive the downlink data signal 120 in the time slots 10, 11 and 12 of the frame 2, which are more than six time slots later from the time slot 8 of the frame 1.

In the step S203 and also in the step Q5, the wireless terminal 10 receives the downlink data signal 120.

In the step S205, the wireless terminal 10 determines to go to the step S207 when it sent ACK information on the uplink control signal 130 of the previous transmission, and otherwise, to go to the step S211. Here, the wireless terminal 10 is assumed to have sent the ACK information.

In the step S207, the wireless terminal 10 inspects and judges whether or not the content of the received downlink data signal 120 is that of sent for the first time from the base station 20. A method of judgment is carried out according to whether or not information that the content is sent for the first time by the base station 20 is written in the downlink data signal 120 or in the downlink control signal 110. When the content of the downlink data signal 120 is new, the wireless terminal determines to go to the step S217, and otherwise, to go to the step S209. Here, the wireless terminal 10 is assumed to have received the downlink data signal 120 containing the same content as the previous one.

The method of judgment set forth above can be substituted by a method as the following. Namely, the base station 20 assigns serial numbers to respectively different contents contained in the downlink data signals 120, which are to be sent consecutively from the base station 20, and writes a serial number into the downlink data signal 120 or into the downlink control signal 110 to be sent to the wireless terminal 10. Accordingly, the wireless terminal 10 can judge whether or not the received downlink data signal 120 contains new content according to the serial number written in the received downlink data signal 120.

In the step S209 and in the steps Q7 and Q9, since the wireless terminal 10 has not received the downlink data signal 120 containing new content though it previously sent the uplink control signal 130 containing ACK information, the wireless terminal 10 determines the previous uplink control signal 130 incorrect and sends information of incorrectness of the previous uplink control signal 130 to the base station 20. For this transmission of the information, the uplink control signal 130 or an uplink data signal can be used. In addition to the information of incorrectness of the uplink control signal 130, the wireless terminal 10 sends information of request for decrement in P_{offset} to the base station 20.

At this step S209, it is also possible to arrange the wireless terminal 10 to decrease the value of P_{offset} stored therein and not to send the information of incorrectness of the uplink control signal 130 to the base station 20. In this latter case, the process jumps from the step Q7 to the step Q11 in the sequence diagram of FIG. 9. Additionally, in the latter case, the transmit power level can be controlled solely from the wireless terminal side.

In the step S217, the wireless terminal 10 judges whether or not it has received the downlink data signal 120 correctly. In a case where it has incorrectly received the signal 120, the wireless terminal 10 determines to go to the step S210, and otherwise, to go to the step S227. Here, the wireless terminal 10 is assumed not to have received the downlink data signal 120 correctly.

In the step S219 and the step Q9, the wireless terminal 10 adds NACK information in the uplink control signal 130.

In the step S221, the wireless terminal 10 calculates a propagation attenuation L_{P-CCPCH,10} of the annunciation signal 100 that is to be sent just before the uplink control signal 130. The method of calculation of the propagation attenuation L_{P-CCPCH,10} is the same as that carried out in the step S111.

In the step S223 and in the step Q11, the wireless terminal 10 determines the transmit power level P_{NACK} of the uplink control signal 130 as the following.

P_{NACK}=L_{P-CCPCH,10}+PRX_{des}+P_{offset} (7)

In the step S225 and in the step Q13, the wireless terminal 10 sends the uplink control signal 130 by the power level of P_{NACK} to the base station 20 in the time slot 9 of the frame 4, the time slot which is more than 19 time slots later.

Hereinafter, processes that the wireless terminal 10 carries out when it has sent NACK information by the previous uplink control signal 130 in the step S205 will be described.

In the step S211, the wireless terminal 10 determines to go to the step S213 when it sent NACK information by the previous uplink control signal 130, and otherwise, to go to the step S217. Here, the wireless terminal 10 is assumed to have sent NACK information by the previous uplink control signal 130.

In the step S213, the wireless terminal 10 judges whether or not the content contained in the received downlink data signal 120 is that which was sent by the base station for the first time to the wireless terminal 10. A method of judgment is the same with that of the step S207. If the content of the downlink data signal 120 is new, the wireless terminal determines to go to the step S215, and otherwise, to go to the step S217. Here, the content is assumed as being new.

In the step S215 and in the steps Q7 and Q9, the wireless terminal 10 judges the previous uplink control signal 130 was incorrect, because the wireless terminal 10 received the downlink data signal 120 containing new content even though it had previously sent an uplink control signal 130 containing NACK information previously. Then, the wireless terminal 10 sends information of incorrectness of the previous uplink control signal 130 to the base station 20. For a signal on which the information of incorrectness to be added, the uplink control signal 130 or the uplink data signal can be used. In addition to the information of incorrectness of the previous uplink control signal, information of request for increment in P_{offset} is sent.

At this step S215, it is also possible to arrange the wireless terminal 10 to increase the value of P_{offset} stored therein and not to send the information of incorrectness of the previous uplink control signal 130 to the base station 20. In this latter case, the process jumps from the step Q7 to the step Q11 in the sequence diagram in FIG. 9. Additionally, in the latter case, the transmit power level can be controlled solely by the wireless terminal side.

The flowchart in FIG. 8 illustrates processes carried out in the base station 20 for deciding an adequate transmit power level of the wireless terminals 10 and 11. In the step S301, the base station 20 goes to the step S303 when it receives information of incorrectness of the uplink control signal 130 that had been sent from one of the wireless terminals 10 and 11 in the step S209 or S215, and otherwise, it terminates the processes of the flowchart in FIG. 8. The information of incorrectness of the uplink control signal may be sent from different wireless terminals, respectively. Hereinafter, the base station 20 is assumed to have received information of incorrectness of the uplink control signal.

In the step S303, the base station 20 carries out error correction of ACK/NACK information contained in the incorrect uplink control signals. Thereafter, when it judges that all previous uplink control signals 130 and 131 contain ACK information, the base station 20 terminates the processes because P_{offset} did not affect to the previous uplink control signals 130 and 131.

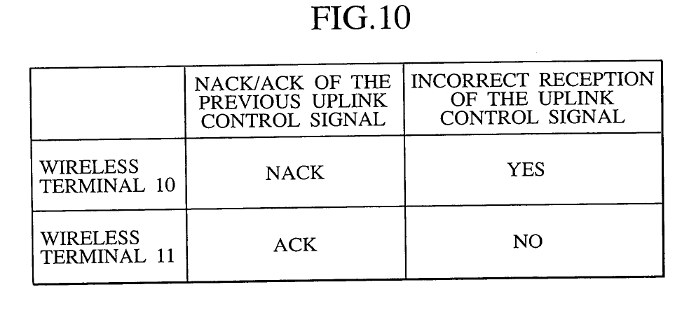

As the table in FIG. 10 illustrates, in a case where the base station 20 has received the previous uplink control signals 130 and 131 and judged to have received NACK from the wireless terminal 10 and ACK from the wireless terminal 11, and that the base station has received information of incorrectness of the uplink control signal 130 from the wireless terminal 10, the base station 20 terminates the processes because, as the result of error correction, it can conclude to have received ACK from both wireless terminals 10 and 11. In the other case, the base station goes to the step S305.

In the step S305, the base station 20 determines to go to the step S307 when at least one case of misjudging ACK as NACK exists, and otherwise, it goes to the step S307.

In the step S307 and in the step Q21, the base station 20 increases P_{offset} by the predetermined value. To the contrary, in the step S309 and in the step Q21, the base station 20 decreases P_{offset} by the predetermined value.

In the step S311 and the step Q23, the base station 20 sends P_{offset} value to all wireless terminals 10 and 11. The base station 20 sends this information in the annunciation signal 100, in the downlink control signals 110 and 111, or in the downlink control signals 120 and 121. Each wireless terminal stores the received information in its memory.

In the step S305, it is possible to arrange the base station 20 to determine which of step S307 or S309 to go to according to the number of pieces of information of incorrect reception of NACK and the number of pieces of information of incorrect reception of ACK. For instance, it is possible to arrange the base station 20 to go to the step S307 when the number of pieces of information of incorrect reception of NACK is larger than that of incorrect reception of ACK, and otherwise to go to the step S309.

According to the second embodiment of the present invention, in the mobile communications system including the wireless terminals and the base station, the wireless terminal side can solely estimate the quality of the uplink control signals and adequately control the transmit power level according to the estimated quality thereof. On the other hand, the base station side can detect the quality of the uplink control signals from the wireless terminals, decide the adequate transmit power level of the uplink control signals according to the detected quality thereof, and inform the adequate transmit power level thereof to all wireless terminals. Consequently, it becomes possible for the mobile communications system to uniform the transmit power level of all wireless terminals to a correct value.

[The Third Embodiment]

A mobile communications system of the third embodiment of the present invention will be described hereinafter. The feature of the third embodiment is another method of deciding P_{offset} in a base station 20 according to uplink control signals 130 and 131 in FIG. 3.

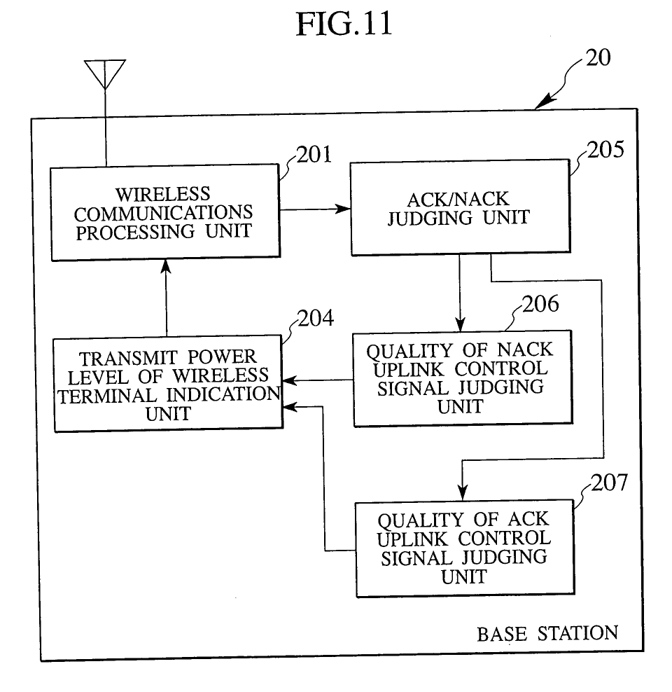

FIG. 11 illustrates a functional scheme of the base station 20. The base station 20 includes a wireless communications processing unit 201, an AKC/NACK judging unit 205, a quality of NACK uplink control signal judging unit 206, a quality of ACK uplink control signal judging unit 207, and a transmit power level of wireless terminal indication unit 204. The wireless communications processing unit 201 carries out wireless communications with wireless terminals 10 and 11. The ACK/NACK judging unit 205 receives uplink control signals and judges the uplink control signals containing ACK/NACK, which are sent from respective wireless terminals 10 and 11. The quality of NACK uplink control signals judging unit 206 judges the quality of the uplink control signals containing NACK information. The quality of ACK uplink control signals judging unit 207 judges the quality of the uplink control signals containing ACK information. The transmit power level of wireless terminal indication unit 204 determines the increment/decrement of a transmit power level of the uplink control signals from the wireless terminals according to the judgment of the quality of NACK uplink control signals and the quality of ACK uplink control signals from respective units 206 and 207.

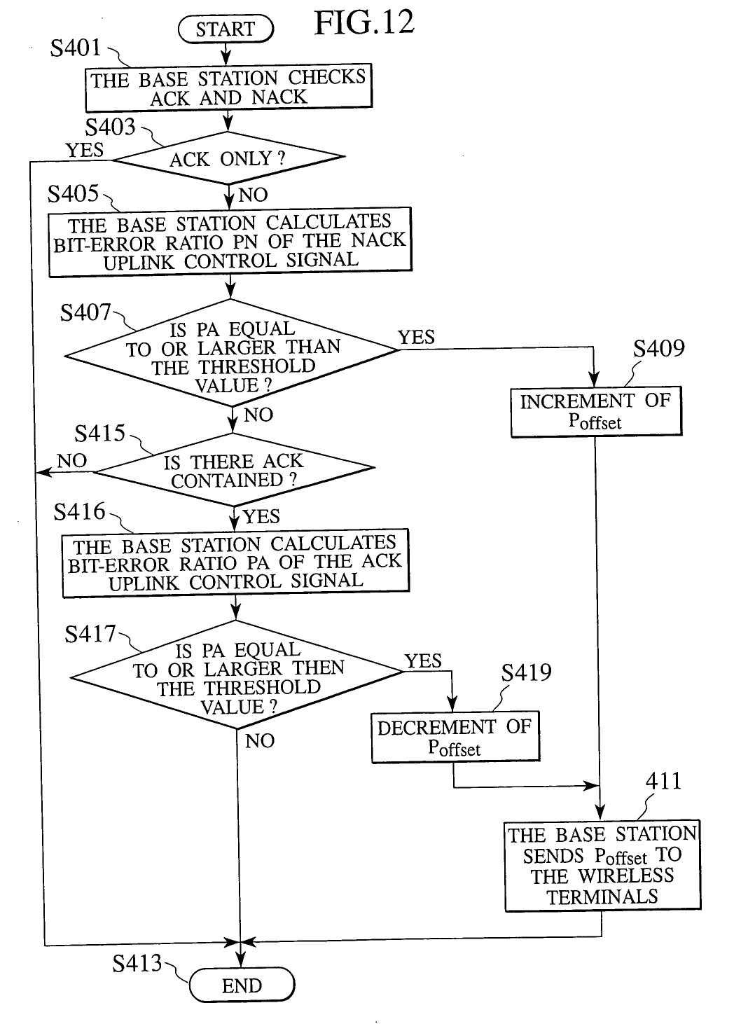

Hereinafter, with reference to a flowchart in FIG. 12, a method of deciding an adequate P_{offset} of uplink control signals that is carried out by the base station 20 according to the received uplink control signals 130 and 131 from the wireless terminals 10 and 11 will be described.

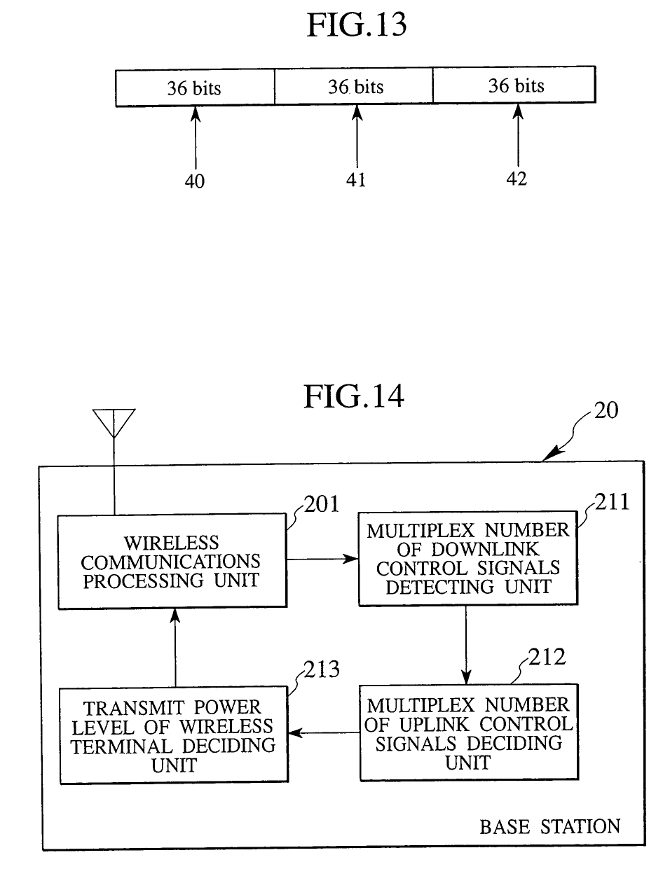

FIG. 13 illustrates a data structure of respective uplink control signals 130 and 131 shown in FIG. 3. A respective uplink control signal comprises an information portion 40 of thirty-six (36) bits reserved for ACK and NACK information, an information portion 41 of thirty (30) bits reserved for signal quality information of respective downlink data signals 120 and 121, and a blank portion 42 of 176 bits. In the information portion 40, a bit string of ACK and a bit string of NACK are set to be different each other at each bit. Here, ACK is set by thirty-six bits of all “0” (zero or low) string and NACK by thirty-six bits of all “1” (one or high) string. Further, the information portion 42 is always set by 176 all “0” bit string. It is allowable to use interleave as bit-handling to each of the information portions 40, 41 and 42 on sending the uplink control signals 130 and 131. The wireless terminal 10 sends the uplink control signal 130 and the wireless terminal 11 sends the uplink control signal 131 as set forth above.

In the step S401, the base station 20 receives the uplink control signals 130 and 131, and judges whether respective uplink control signals is ACK or NACK according to the bit string of the information portion 40. One method of judging ACK or NACK is to inspect every bit of the information portion 40 “0” or “1” and determine the uplink control signal is ACK when nineteen or more bits are “1”, and otherwise, determine NACK. Alternatively, it is possible to employ the method of maximum likelihood for a standardized bit string, in which every bit of the information portion 40 is standardized, before judgment of ACK or NACK.

In the step S403, the base station 20 determines to terminate the process when, as the result of judgment in the step S401, all received uplink control signals 130 and 131 are ACK, and otherwise, the base station determines to go to the step S405. Here, it is supposed that the wireless terminal 10 has sent ACK and the wireless terminal 11 has sent NACK.

In the step S405, the base station 20 calculates a bit error ratio PN of the uplink control signal 131, which has been judged NACK. The base station calculates this bit error ratio PN by counting error bits of the information portion 40 or 42. It is applicable by counting error bits of both information portions 40 and 42, or by counting error bits of the information portion 41. It is also applicable to use signal-to-noise ratio SNRn of the uplink control signal instead of the PN.

In the step S407, the base station 20 compares the bit error ratio PN with a predetermined threshold value, or compares the signal-to-noise ratio SNRn with a predetermined threshold value. When the PN is equal to or larger than the threshold value or the SNRn is equal to or smaller than the threshold value, the base station 20 goes to the step S409, and otherwise goes to the step S415. Here, the threshold value for the bit error ratio PN is set to such a value that the uplink control signals 130 and 131 can be correctly received by the base station 20 when the PN is smaller than that value. Similarly, the threshold value for the signal-to-noise ration SNRn is set to such a value that the uplink control signals 130 and 131 can be correctly received by the base station 20 when the SNRn is larger than that value. It is assumed here that the bit error ratio PN of the uplink control signal 131 from the wireless terminal 11 is detected as being larger than the threshold value.

In the step S409, the base station 20 determines to increase the P_{offset}. It is possible to set the P_{offset} to be increased by a constant value. Alternatively, it is also possible to set the base station 20 to store a table defining relationship between increment/decrement values and PN values (or SNRn values) in its memory beforehand, and to refer to the table in order to determine an increment value.

In the step S411, the base station 20 sends the P_{offset} to the wireless terminals 10 and 11. The timing of transmission of this value P_{offset} is set for the base station 20 to send periodically or at arbitrary timings by using the annunciation signal 100, the downlink control signals 110 and 111 or the downlink data signals 120 and 121. The wireless terminals 10 and 11 store in their memories the P_{offset} value sent from the base station 20.

The following process will be carried out by the base station 20 when it goes to the step S415 from the step S407 because the PN is not equal to nor larger than the threshold value, or the SNRn is not equal to nor smaller than the threshold value.

In the step S415, the base station 20 goes to the step S416 when at least one ACK signal was found among the received uplink control signals 130 and 131, and otherwise, it terminates the processes. In this case, the base station 20 goes to the step S416 because the wireless terminal 10 is supposed to have sent ACK.

In the step S416, the base station 20 calculates a bit error ratio PA of the uplink control signals, which have been judged ACK. The base station calculates this bit error ratio PA by counting error bits of the information portion 40 or 42. It is applicable by counting error bits of both information portions 40 and 42, or by counting error bits of the information portion 41. It is also applicable to use signal-to-noise ratio SNRa of the uplink control signal instead of the PA.

In the step S417, the base station 20 compares the bit error ratio PA with a predetermined threshold value, or compares the signal-to-noise ratio SNRa with a predetermined threshold value. When the PA is equal to or larger than the threshold value or the SNRa is equal to or smaller than the threshold value, the base station 20 goes to the step S419, and otherwise goes to the step S413. Here, it is assumed that the bit error ratio PA of the uplink control signal 130 from the wireless terminal 10 is detected as being larger than the threshold value.

In the step S419, the base station 20 determines to decrease the P_{offset}. It is possible to set the P_{offset} to be decreased by a constant value. Alternatively, it is also possible to set the base station 20 to store a table defining relationship between increment/decrement values and PA values (or SNRa values) in its memory beforehand, and to refer to the table in order to determine a value of decrease. In the step S411, as set forth above, the base station 20 also sends the P_{offset} to the wireless terminals 10 and 11.

For this method of deciding an adequate transmit power level, in the step S401, it is possible to arrange for the wireless terminals 10 and 11 to detect errors of the uplink control signals 130 and 131 and send the error information to the base station 20, and for the base station 20 to receive the error information from the wireless terminals 10 and 11 and correct ACK and NACK bit string before the judgment thereof.

It is also possible to inverse the bit string of ACK and that of NACK. Further, it is possible to differ all threshold values for the bit error ratio PN and PA and for the signal-to-noise ratio SNRn and SNRa, respectively.

According to the third embodiment of the present invention, the wireless terminals judge errors of the uplink control signals and the base station determines the adequate transmit power level of the uplink control signals for NACK according to errors of the uplink control signals. Consequently, it can lessen the degradation of receive quality of the uplink control signals.

Furthermore, the base station measures a wireless signal quality such as the bit error ratio or the signal-to-noise ratio of the uplink control signals and determines the adequate transmit power level of the uplink control signals for NACK according to the measured wireless signal quality. Consequently, the degradation of receive quality of the uplink control signals can be minimized and the load on the wireless terminals for adjustment of the transmit power level of the uplink control signals can be lessened.

Since estimation of the correct information is easy for the information portions 40 and 42, the error measurement of the uplink control signals by using these protions is also easy. Accordingly, by using these information portions for detecting the quality of the uplink control signals, high accuracy of measurement of the quality of the uplink control signals is achievable.

[The Fourth Embodiment]

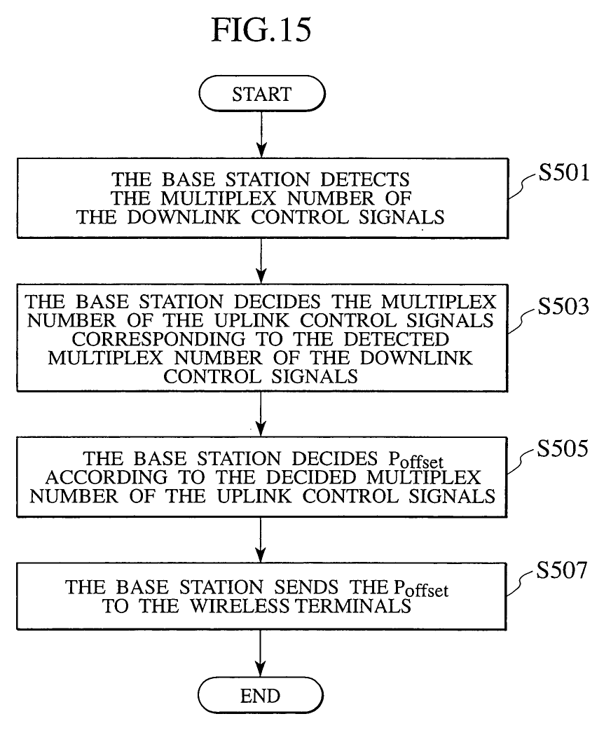

A mobile communications system of the fourth embodiment of the present invention will be described hereinafter with reference to FIGS. 14 and 15. The scheme of the mobile communications system of the fourth embodiment is the same as that of the first embodiment shown in FIG. 1. The feature of the fourth embodiment is a function of a base station 20. The base station 20 includes a wireless communications processing unit 201, a multiplex number of downlink control signals detecting unit 211, a multiplex number of uplink control signals deciding unit 212 and a transmit power level of wireless terminal deciding unit 213. The wireless communications processing unit 201 processes wireless communications with wireless terminal 10 and 11. The multiplex number of downlink control signals detecting unit 211 detects a multiplex number of downlink control signals to be sent out from the base station 20 to the wireless terminals 10 and 11. The multiplex number of uplink control signals deciding unit 212 decides a multiplex number of uplink control signals to be sent from the wireless terminals 10 and 11. The multiplex number of uplink control signals is determined so as to correspond to the detected multiplex number of downlink control signals. The transmit power level of wireless terminal deciding unit 213 calculates a transmit power level P_{offset} of the uplink control signals to be sent from the wireless terminals 10 and 11 according to the multiplex number of uplink control signals that is decided by the multiplex number of uplink control signals deciding unit 212, and sends the P_{offset} value via the wireless communications processing unit 201 to the wireless terminals 10 and 11. The P_{offset} value is sent in the downlink control signals or downlink data signals.

Hereinafter, a method of deciding a transmit power level of uplink control signals carried out in the base station 20 will be described with reference to the flowchart of FIG. 15.

In the step S501, the base station 20 detects the multiplex number of downlink control signals when the signals are being sent out to the wireless terminals.

In the step S503, the base station 20 decides the multiplex number of uplink control signals according to the detected multiplex number of downlink control signals so as to correspond to the detected multiplex number thereof.

In the step S505, the base station 20 calculates a suitable transmit power level P_{offset} of the uplink control signals according to the decided multiplex number of uplink control signals.

In the step S507, the base station 20 sends the newly calculated P_{offset} value to the wireless terminals 10 and 11. The P_{offset} value will be sent in the downlink control signals or the downlink data signals.

The wireless terminals 10 and 11 receive the P_{offset} value and control the transmit power level of the uplink control signals to fit the indicated P_{offset} value.

According to the fourth embodiment of the present invention, in the mobile communications system including the wireless terminals 10 and 11 and the base station 20, the base station 20 solely decides the multiplex number of uplink control signals and also decides an adequate transmit power level of the uplink control signals according to the decided multiplex number thereof, and indicates the adequate transmit power level of the uplink control signals to the wireless terminal. Consequently, the wireless terminals 10 and 11 can adequately carry out wireless communications with the base station 20 by merely controlling the transmit power level of the uplink control signals so as to agree with the indicated transmit power level. As a result, the load for adjustment of the transmit power level of the uplink control signals that is required to the wireless terminal side does not increase.

What is claimed is:

1. A method of deciding a transmit power level carried out by a wireless terminal in a mobile communications system comprising the steps of:
deciding a multiplex number of uplink control signals; and
deciding a transmit power level according to the decided multiplex number of uplink control signals.

2. A method of deciding a transmit power level carried out by a wireless terminal in a mobile communications system comprising the steps of:
estimating a quality of an uplink control signal; and
deciding a transmit power level according to the estimated quality of the uplink control signal.

3. A method of deciding a transmit power level carried out by a base station in a mobile communications system comprising the steps of:
deciding a multiplex number of uplink control signals;
deciding a transmit power level according to the decided multiplex number of uplink control signals; and
sending the decided transmit power level as an indication value to a wireless terminal.

4. A method of deciding a transmit power level carried out by a base station in a mobile communications system comprising the steps of:
detecting a quality of an uplink control signal;
deciding a transmit power level according to the detected quality of the uplink control signal; and
transmitting to a wireless terminal the decided transmit power level as an indication value.

5. A method of deciding a transmit power level in a mobile communications system, in which the system includes a plurality of wireless terminals and a base station, comprising the steps of:
(a) a step that the plurality of wireless terminals estimate a quality of an uplink control signal, respectively;
(b) a step that the plurality of wireless terminals inform a degradation of the uplink control signal to the base station when they estimated the degradation thereof, respectively;
(c) a step that the base station decides to increase the transmit power level of the uplink control signal from one of the plurality of wireless terminals when the base station received from one of the plurality of wireless terminals an information that the quality of the uplink control signal for informing an incorrect receipt of a downlink data signal is degraded, whereas the base station decides to decrease the transmit power level of the uplink control signal from one of the plurality of wireless terminals when the base station received from one of the plurality of wireless terminals an information that the quality of the uplink control signal for informing a correct receipt of the downlink data signal is degraded; and
(d) a step that the base station sends an indication value of the decided transmit power level of the uplink control signal to all of the plurality of wireless terminals.

6. A wireless terminal comprising:
a multiplex number deciding means for deciding a multiplex number of uplink control signals;
a transmit power level deciding means for deciding a transmit power level of the uplink control signals according to the multiplex number of uplink control signals decided by the multiplex number deciding means; and
a transmit power control means for controlling a transmit power level of the uplink control signals according to the decided transmit power level by the transmit power level deciding means.

7. A wireless terminal in accordance with claim 6: wherein the transmit power level deciding means decides an increment in the transmit power level when the multiplex number of uplink control signals is large, whereas the transmit power level deciding means decides a decrement in the transmit power level when the multiplex number of uplink control signals is small.

8. A wireless terminal in accordance with claim 6: wherein the multiplex number deciding means decides the multiplex number of uplink control signals according to a multiplex number of downlink control signals corresponding thereto.

9. A wireless terminal in accordance with claim 8: wherein the multiplex number deciding means measures the multiplex number of downlink control signals corresponding to the uplink control signals and decides the multiplex number of uplink control signals according to the measured multiplex number of downlink control signals.

10. A wireless terminal in accordance with claim 6: wherein the transmit power level of the uplink control signal is a transmit power level of an uplink control signal for informing an incorrect receipt of a downlink data signal from a base station.

11. A wireless terminal comprising:
a signal quality estimation means for estimating a quality of an uplink control signal;
a transmit power level deciding means for deciding a transmit power level according to the estimated quality of the uplink control signal; and
a transmit power control means for controlling a transmit power level of the uplink control signal according to the decided transmit power level by the transmit power level deciding means.

12. A wireless terminal in accordance with claim 11: wherein
the signal quality estimation means estimates the quality of the uplink control signal for informing an incorrect receipt of a downlink data signal from a base station and the quality of the uplink control signal for informing a correct receipt of the downlink data signal; and
the transmit power level deciding means decides an increment in the transmit power level of the uplink control signal when the signal quality estimation means estimates that the quality of the uplink control signal for informing an incorrect receipt of the downlink data signal is degraded, and decides a decrement in the transmit power level of the uplink control signal when the signal quality estimation means estimates that the quality of the uplink control signal for informing a correct receipt of the uplink control signal is degraded.

13. A wireless terminal in accordance with claim 11: wherein the signal quality estimation means estimates the quality of the uplink control signal according to the downlink data signal from the base station.

14. A wireless terminal in accordance with claim 13: wherein the signal quality estimation means decides that the quality of the uplink control signal for informing a correct receipt of the downlink data signal is degraded in a case where the wireless terminal receives the downlink data signal of informing the same massage with that was previously received after the wireless terminal sent an uplink control signal for informing a correct receipt of the downlink data signal which was previously received.

15. A wireless terminal in accordance with claim 13: wherein the signal quality estimation means decides that the quality of the plink control signal for informing an incorrect receipt of the downlink data signal is degraded in a case where the wireless terminal receives the downlink data signal of informing a different massage from that was previously received after the wireless terminal sent an uplink control signal for informing an incorrect receipt of the downlink data signal which was previously received.

16. A wireless terminal in accordance with claim 11: wherein the transmit power level of the uplink control signal is a transmit power level of an uplink control signal for informing an incorrect receipt of a downlink data signal from a base station.

17. A base station comprising:
a multiplex number of signals deciding means for deciding a multiplex number of uplink control signals from a wireless terminal;
a transmit power level deciding means for deciding a transmit power level according to the decided multiplex number of uplink control signals; and
a transmit power level indicating means for sending the decided transmit power level as an indication value to the wireless terminal.

18. A base station in accordance with claim 17: wherein the transmit power level deciding means decides an increment in the transmit power level of the uplink control signals when the decided multiplex number of uplink control signals is large, and decides a decrement in the transmit power level of the uplink control signals when the decided multiplex number of uplink control signals is small.

19. A base station in accordance with claim 17: wherein the multiplex number of signals deciding means decides the multiplex number of uplink control signals according to a multiplex number of downlink control signals.

20. A base station in accordance with claim 19: wherein the multiplex number of signals deciding means measures the multiplex number of downlink control signals and decides the multiplex number of uplink control signals according to the measured multiplex number of downlink control signals.

21. A base station in accordance with claim 17: wherein the transmit power level of the uplink control signals is a transmit power level of uplink control signals for informing an incorrect receipt of downlink data signals.

22. A base station comprising:
a signal quality detecting means for detecting a quality of an uplink control signal from a wireless terminal;
a transmit power level deciding means for deciding a transmit power level according to the detected quality of the uplink control signal; and
a transmit power level indicating means for sending the decided transmit power level as an indication value to the wireless terminal.

23. A base station in accordance with claim 22: wherein
the signal quality deciding means decides that a quality of an uplink control signal from the wireless terminal for the purpose of informing an incorrect receipt of a downlink data signal is degraded, and decides that a quality of an uplink control signal from the wireless terminal for the purpose of informing a correct receipt of the downlink data signal is degraded; and
the transmit power level deciding means decides to increase the transmit power level of the uplink control signal from the wireless terminal when the base station received from the wireless terminal an information that the quality of the uplink control signal for informing the incorrect receipt of the downlink data signal is degraded, and decides to decrease the transmit power level of the uplink control signal from the wireless terminal when the base station received from the wireless terminal an information that the quality of the uplink control signal for informing the correct receipt of the downlink data signal is degraded.

24. A base station in accordance with claim 23: wherein the signal quality deciding means decides the quality of the uplink control signal according a bit error rate or a signal-to-noise ratio of at least one of a portion of informing the correct receipt of the downlink data signal and a blank portion thereof.

25. A base station in accordance with claim 22: wherein the transmit power level of the uplink control signal is a transmit power level of an uplink control signal from the wireless station for the purpose of informing an incorrect receipt of the downlink data signal.

26. A mobile communications system comprising a plurality of wireless terminals and a base station: wherein
the plurality of wireless terminals respectively are configured to estimate a quality of uplink control signal and to inform degradation of the quality of the uplink control signals to the base station in a case where one of the respective wireless terminals estimate the degradation of the quality of the uplink control signals; and
the base station is configured to decide to increase a transmit power level of the uplink control signals from each of the wireless terminals when the base station received from one of the wireless terminals an information that the quality of the uplink control signals for informing an incorrect receipt of the downlink data signals is degraded and to decide to decrease the transmit power level of the uplink control signals from each of the wireless terminals when the base station received from one of the wireless terminals an information that the quality of the uplink control signals for informing a correct receipt of the downlink data signals is degraded, and to send an indication value of the transmit power level to all of the plurality of wireless terminals.
